(19) United States
(12) Patent Application Publication
(10) Pub. No.: US 2021/0108694 A1
(43) Pub. Date: Apr. 15, 2021

(54) REFRIGERATION DEVICE COMPRISING A DAMPING DISC

(71) Applicant: BSH HAUSGERAETE GMBH, MUENCHEN (DE)

(72) Inventors: SIMON MAYER, DORNSTADT (DE); MARTIN SCHIMMELE, UNTERSCHNEIDHEIM (DE)

(21) Appl. No.: 16/606,488

(22) PCT Filed: Mar. 28, 2018
(86) PCT No.: PCT/EP2018/057872

§ 371 Date: Oct. 18, 2019

(30) Foreign Application Priority Data
Apr. 18, 2017 (DE) 10 2017 206 505.2

(51) Int. Cl. F16F 1/376; F04D 29/66; F25D 11/02; F25D 17/06; F25D 23/06; F16F 1/377

(52) U.S. Cl. CPC F16F 1/376; F04D 29/668; F25D 11/02; F25D 2317/06; F25D 23/065; F16F 1/377; F25D 17/065

(57) ABSTRACT

A refrigeration appliance has a cooling chamber for receiving products to be refrigerated, the cooling chamber being delimited by a cooling chamber wall. A fan is fastened to the cooling chamber wall and is configured to deliver air through an air channel of the refrigeration appliance to the cooling chamber. A damping disc is located on a side of the fan close to the cooling chamber wall. The damping disc has a plurality of elevations which lie against the cooling chamber wall, and the damping disc has a plurality of apertures extending in a peripheral direction of the damping disc. The damping disc is configured to damp vibrations which arise during operation of the fan in order to separate the fan and the cooling chamber wall in terms of vibration.

The present invention relates to a refrigeration appliance comprising a damping disc.

During the operation of a refrigeration circuit of a refrigeration appliance, a refrigerating compartment of the refrigeration appliance for receiving chilled goods is cooled. The refrigeration circuit comprises a refrigerant evaporator that is configured as a heat exchanger, in which after the expansion the liquid refrigerant is evaporated by absorbing heat from the medium, for example air, that is to be cooled. The cooled air is supplied by a fan of the refrigeration appliance via an air duct to the refrigerating compartment in order to effectively cool the refrigerating compartment. By virtue of the fact that the fan is attached to a refrigerating compartment wall of the refrigeration appliance, it is possible for vibrations to occur during the operation of the fan, said vibrations may be transmitted to the refrigeration appliance by means of the refrigerating compartment wall and possibly generate resonances that may be perceived by the user of the refrigeration appliance as unpleasant.

DE 10 2012 218 347 A1 discloses a refrigeration appliance having a fan assembly that is attached to a housing rear wall part and is fixed by means of a housing front wall part.

It is the object of the present invention to propose a refrigeration appliance that may be operated quietly.

This object is achieved by means of a subject matter having the features according to the independent claim. Advantageous embodiments are the subject matter of the dependent claims, the description and the drawings.

In accordance with one aspect, the object in accordance with the invention is achieved by means of a refrigeration appliance having a refrigerating compartment for receiving chilled goods, wherein the refrigerating compartment is defined by means of a refrigerating compartment wall, a fan that is attached to the refrigerating compartment wall and is configured so as to supply air via an air duct of the refrigeration appliance to the refrigerating compartment, and a damping disc that is arranged on a side of the fan that is facing one of the refrigerating compartment walls, wherein the damping disc comprises a multiplicity of elevations that lie against the refrigerating compartment wall, wherein the damping disc comprises a multiplicity of through-going holes that extend in a circumferential direction of the damping disc, and wherein the damping disc is configured so as to dampen vibrations that occur during the operation of the fan in order to separate the fan and the refrigerating compartment wall with regard to the transmission of vibrations.

As a consequence, by way of example the technical advantage is achieved that it is possible by means of the damping disc to achieve a particularly effective separation between the fan and the refrigerating compartment wall with regard to the transmission of vibrations with the result that the refrigeration appliance may be operated quietly.

The elevations that are arranged on the damping disc lie in this case against the refrigerating compartment wall and consequently reduce the contact area between the fan and the refrigerating compartment wall. As a result, in particular axial oscillations between the fan and the refrigerating compartment wall are damped. Consequently, it is possible to ensure a particularly effective reduction of the vibrations that are transmitted between the fan and the refrigerating compartment wall.

Moreover, the damping disc comprises a multiplicity of through-going holes that extend in the circumferential direction of the damping disc, wherein the through-going holes in this case form in particular a circle of elongated holes within the damping disc, and wherein the through-going holes that are configured as elongated holes are separated from one another in particular by means of webs between said through-going holes. The through-going holes that extend in a circumferential direction of the damping disc absorb the torque that is produced as the fan motor starts up or in the case of a speed change of the fan wheel, in other words the through-going holes reduce torsional oscillations that occur as a result. It is possible for the torque to be absorbed by virtue of the fact that the damping disc is locally deformed in the region of the through-going holes by means of the torque that occurs and said damping disc subsequently springs back in an elastic manner to its original shape. In this case, the damping disc is arranged in particular spaced apart in the radial direction from the axis of rotation of the fan wheel or rather of the fan motor in order to render it possible for torsional oscillations that occur to be absorbed in a particularly effective manner.

The advantage is achieved by means of the damping disc that different vibration frequencies that may be produced by means of the fan motor of the fan are not transmitted directly to the refrigerating compartment wall and consequently not transmitted directly to the adjoining components of the refrigeration appliance. Consequently, the degree of freedom when designing the fan or rather when designing the attachment of the fan to the refrigeration appliance increases since it is not necessary to take into consideration the vibration resistance of the components as a primary focal point of the development process. By virtue of the detailed design of the material of the damping disc or rather by virtue of the geometric shape of the through-going holes and the elevations, it is possible to achieve a particularly effective damping arrangement that is adapted to the relevant installation situation.

The diameter of the damping disc is in particular between 20 mm and 30 mm, in particular approx. 25 mm.

A refrigeration appliance is understood in particular to be a household refrigeration appliance, in other words a refrigeration appliance that is used for household management in households or in the gastronomic industry, and in particular is used for storing foodstuffs and/or drinks at specific temperatures, such as by way of example a refrigerator, a freezer, a fridge-freezer combination, a chest freezer or a wine cooler.

In one advantageous embodiment of the refrigeration appliance, the damping disc comprises an outer surface and an inner surface, wherein the elevations are arranged on the outer surface and/or on the inner surface and wherein the outer surface and/or the inner surface lie in particular against the refrigerating compartment wall.

As a consequence, the technical advantage is achieved that the elevations that are arranged on the inner surface and/or on the outer surface render it possible to achieve a particularly effective damping of axial vibrations if the inner surface and/or the outer surface lie against the refrigerating compartment wall.

In one advantageous embodiment of the refrigeration appliance, the damping disc has an outer disc and an inner disc, wherein the outer disc is connected to the inner disc by means of a disc-connecting portion, wherein in particular the disc-connecting portion comprises a first diameter, the outer disc comprises a second diameter and the inner disc comprises a third diameter, wherein the first diameter is less than the second diameter and wherein the first diameter is less than the third diameter.

As a consequence, the technical advantage is achieved that the outer disc and/or the inner disc may lie effectively against the refrigerating compartment wall in order to effectively damp vibrations. In this case, the outer disc comprises in particular the outer surface and the inner disc comprises the inner surface, wherein in this case the inner disc and/or the outer disc lie against the refrigerating compartment wall and wherein in this case the disc-connecting portion does not lie against the refrigerating compartment wall. By virtue of the first diameter of the disc-connecting portion being in particular less than the second and the third diameter of the inner disc and of the outer disc, it is rendered possible by means of the disc-connecting portion to effectively attach the damping disc to the fan.

In one advantageous embodiment of refrigeration appliance, the elevations respectively comprise a rounded surface and are configured in particular as semi-spheres.

As a consequence, the technical advantage is achieved that the rounded surfaces of the elevations or rather the surfaces in the form of semi-spheres ensure a particularly effective reduction of the contact area between the elevations and the refrigerating compartment wall.

In one advantageous embodiment of the refrigeration appliance, the damping disc comprises a middle axis that extends from a disc middle point of the damping disc in an orthogonal manner to the disc side of the damping disc, wherein the through-going holes that extend in the circumferential direction of the damping disc are arranged at least in sections in a circumferential manner around the middle axis.

As a consequence, the technical advantage is achieved that by means of the through-going holes that are arranged in a circumferential manner around the middle axis, it is ensured that the torsional oscillations are particularly effectively absorbed by means of the damping disc.

In one advantageous embodiment of the refrigeration appliance, the through-going holes that extend in the circumferential direction of the damping disc are configured as elongated holes.

As a consequence, the technical advantage is achieved that by means of the through-going holes that are configured as elongated holes, the damping disc is provided with a circle of elongated holes that advantageously effectively absorb the torsional oscillations.

In one advantageous embodiment of the refrigeration appliance, the damping disc comprises a central through-going hole that is arranged in a disc middle of the damping disc, wherein the central through-going hole is configured so as to receive an attachment dome that is arranged on the refrigerating compartment wall in order to attach the damping disc to the refrigerating compartment wall.

As a consequence, the technical advantage is achieved that by means of inserting the attachment dome into the central through-going hole of the damping disc, it is ensured that the damping disc is attached to the refrigerating compartment wall in a particularly effective manner.

In one advantageous embodiment of the refrigeration appliance, the attachment dome comprises an attachment protrusion, wherein the attachment protrusion is configured so as to attach the damping disc between the fan and the refrigerating compartment wall, in particular to attach said damping disc in a positive locking and/or non-positive locking manner.

As a consequence, the technical advantage is achieved that the attachment protrusion renders it possible to attach the damping disc to the refrigerating compartment wall in a particularly advantageous manner. The attachment protrusion lies in this case in particular against an inner surface of an inner disc of the damping disc in a positive locking manner and/or the attachment protrusion exerts a force in particular on an inner surface of an inner disc of the damping disc in order to attach the damping disc to the refrigerating compartment wall in an effective manner by means of the attachment dome.

In one advantageous embodiment, the central through-going hole is defined by means of an inner edge of the damping disc, wherein a multiplicity of additional elevations is formed on the inner edge, wherein the additional elevations are configured so as to separate the fan and the refrigerating compartment wall with regard to the transmission of vibrations, and wherein the additional elevations are configured in particular as webs that extend on the inner edge from an outer surface to an inner surface of the damping disc.

As a consequence, the technical advantage is achieved that by means of the additional elevations, in particular webs, which are formed in the central through-going hole of the damping disc, it is possible to advantageously reduce the contact area between the damping disc and the attachment dome of the refrigerating compartment wall. As a consequence, it is possible to advantageously reduce the transmission of vibrations between the damping disc and the refrigerating compartment wall.

In one advantageous embodiment, the damping disc comprises an elastically deformable material, in particular silicone.

As a consequence, the technical advantage is achieved that an elastically deformable material, such as for example silicone, renders it possible by means of the deformability of said material to absorb vibrations in a particularly effective manner and as a result of the deformation in the circumferential direction of the damping disc to effectively receive and absorb in particular torsional oscillations. In one advantageous embodiment, the fan comprises at least one connecting portion, wherein the connecting portion comprises a connecting opening into which it is possible to insert an attachment dome that is arranged on the refrigerating compartment wall in order to connect the fan to the refrigerating compartment wall, wherein the damping disc is arranged between the connecting portion and the refrigerating compartment wall in order to separate the fan and the refrigerating compartment wall with regard to the transmission of vibrations.

As a consequence, the technical advantage is achieved that it is ensured that the fan is attached to the refrigerating compartment wall in a manner whereby they are effectively separated from one another with regard to the transmission of vibrations since the damping disc is arranged between the connecting portion and the refrigerating compartment wall. In this case, the attachment done of the refrigerating compartment wall is in particular initially guided through the central through-going hole of the damping disc in order to plug the damping disc onto the attachment dome, wherein subsequently the attachment dome with the plugged-on damping disc is guided through the connecting opening of the connecting portion of the fan.

In one advantageous embodiment, the fan comprises a fan unit that is configured so as to convey air to the refrigerating compartment and the fan comprises a fan holding device that is configured so as to fix the fan to the refrigerating compartment wall.

As a consequence, the technical advantage is achieved that the fan comprises separate functional units that ensure an effective operation of the fan. In particular, a fan motor for driving a fan wheel is arranged in the fan unit, whereby air may be effectively conveyed via the air duct. The fan holding device ensures that the fan unit is effectively held on the refrigerating compartment wall.

In one advantageous embodiment, the fan unit is connected to the fan holding device by means of a releasable connection, in particular by means of a bayonet connection.

As a consequence, the technical advantage is achieved that by means of the releasable connection, in particular a bayonet connection, it is ensured that the procedure of assembling the fan unit and the fan holding device is simplified.

In one advantageous embodiment, the fan holding device comprises at least one holding arm, wherein the holding arm respectively comprises a connecting portion that is connected to the refrigerating compartment wall.

As a consequence, the technical advantage is achieved that by means of the at least one holding arm the connecting portion may be positioned spaced apart from the fan unit on the refrigerating compartment wall, whereby it is ensured that the fan holding device is positioned on the refrigerating compartment wall in a stable manner. In particular, the fan holding device comprises a multiplicity of holding arms, in particular three holding arms, which extend outward from a central portion of the fan unit.

In one advantageous embodiment, the damping disc comprises a circumferential recess, wherein the connecting portion is configured so as to engage in the circumferential recess in order to connect the damping disc to the connecting portion and wherein the damping disc is connected to the connecting portion in particular in a positive locking and/or non-positive locking manner.

As a consequence, the technical advantage is achieved that it is possible to insert the connection portion effectively into the circumferential recess in the damping disc in order to attach the damping disc advantageously to the connecting portion.

Further exemplary embodiments are explained with reference to the attached drawings. In the drawings:

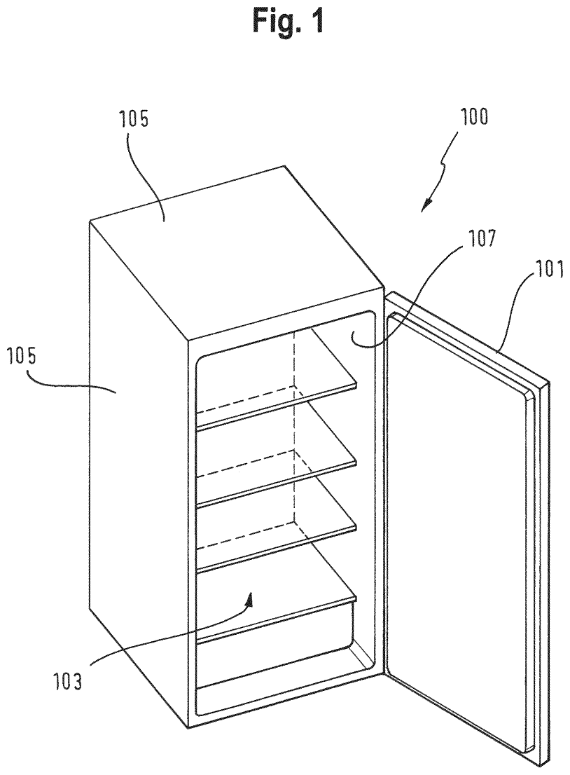

FIG. 1 shows a schematic representation of a refrigeration appliance;

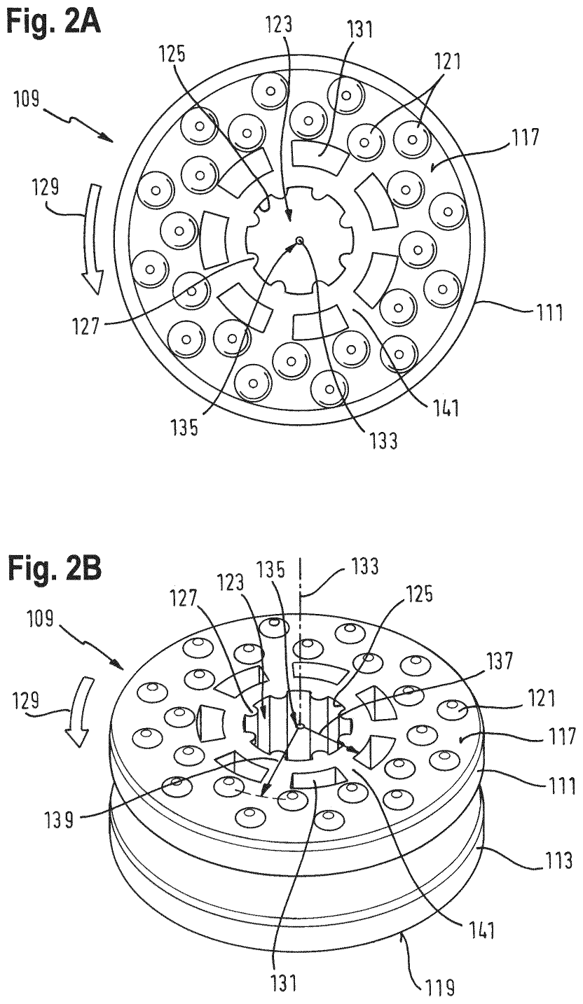

FIGS. 2A, 2B show schematic representations of a damping disc that is arranged on a fan of a refrigeration appliance;

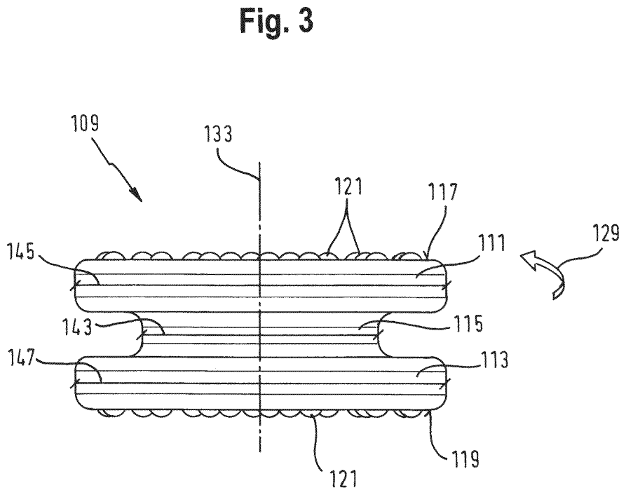

FIG. 3 shows a schematic representation in a side view of a damping disc that is arranged on a fan of a refrigeration appliance;

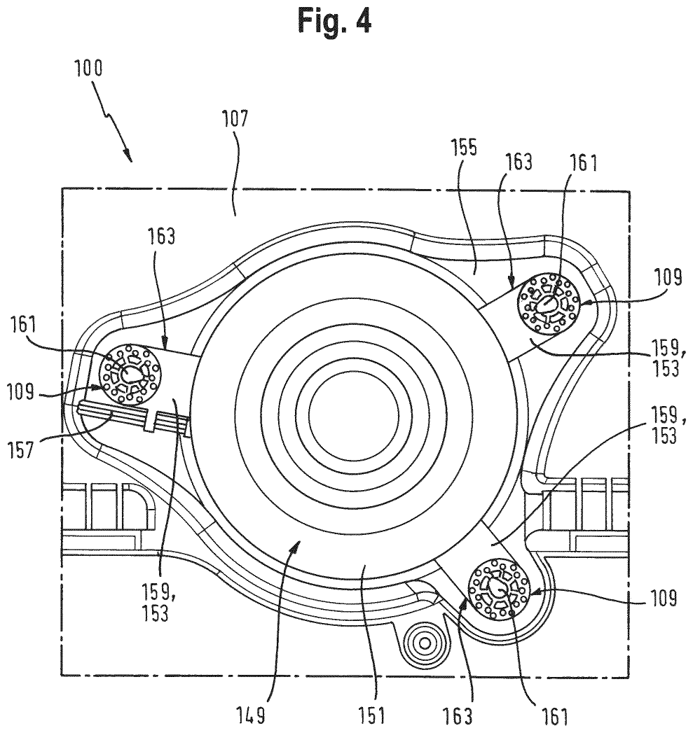

FIG. 4 shows a schematic representation of a fan that is attached to a refrigerating compartment wall of the refrigeration appliance; and

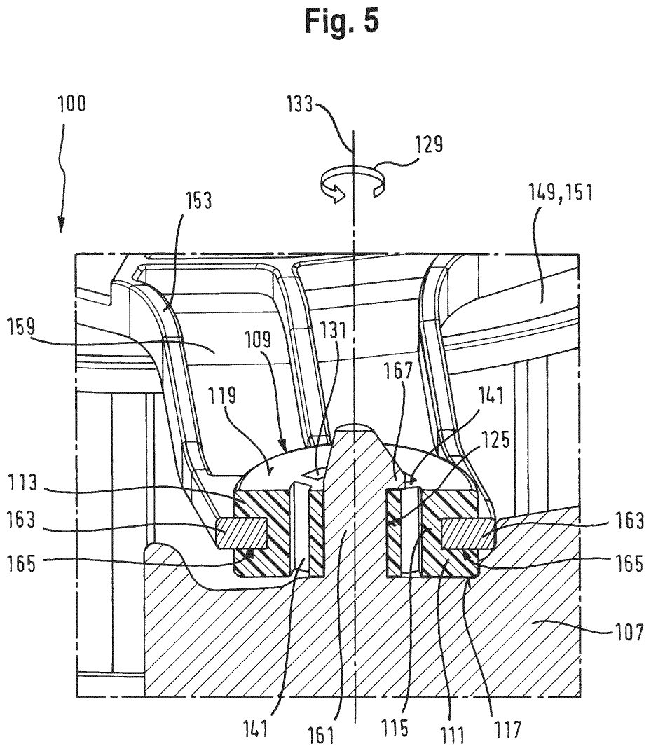

FIG. 5 shows a sectional view of a connection between a fan and a refrigerating compartment wall of the refrigeration appliance.

FIG. 1 illustrates a refrigerator representing a common refrigeration appliance 100 having a refrigeration appliance door 101 for closing off a refrigerating compartment 103 of the refrigeration appliance 100 and having a housing outer wall 105 of the refrigeration appliance 100. The refrigerating compartment 103 of the refrigeration appliance 100 is defined by a refrigerating compartment wall 107.

The refrigeration appliance 100 comprises one or multiple refrigerant circuits having respectively a refrigerant evaporator, a refrigerant compressor, a refrigerant condenser and a restrictor. The refrigerant evaporator is a heat exchanger in which after the expansion the liquid refrigerant is evaporated by means of absorbing heat from the medium that is to be cooled, for example air. The refrigerant compressor is a mechanically driven component that draws in refrigerant vapor from the refrigerator evaporator and discharges said refrigerant at a higher pressure into the refrigerant condenser. The refrigerant condenser is a heat exchanger in which after the compression the vaporized refrigerant is condensed by means of dissipating heat to an external cooling medium, for example air. The refrigeration appliance 100 comprises a fan that is configured so as to convey an air flow to the refrigerant condenser and the refrigerant evaporator. The air flow produces an effective heat supply to the refrigerant evaporator and the air that is cooled thereby may be conveyed to the refrigerating compartment 103 via an air duct of the refrigeration appliance 100. The restrictor is a device for continuously reducing the pressure by means of a narrowing cross section. The refrigerant is a fluid that is used for the transmission of heat in the refrigerant circuit and in the case of low temperatures and low pressure of the fluid absorbs heat and in the case of a higher temperature and a higher pressure of the fluid gives off heat, wherein this includes usual changes of state of the fluid.

FIGS. 2A and 2B illustrate schematic representations of a damping disc 109 that may be attached to a fan of a refrigeration appliance 100. FIG. 2A illustrates a top view of the damping disc 109, whereas FIG. 2B illustrates a side view of the same damping disc 109.

The damping disc may be formed from an elastically deformable material, in particular silicone, in order to effectively damp vibrations that occur during the operation of the fan.

The damping disc 109 is configured as a double disc that comprises an outer disc 111 and an inner disc 113, wherein the outer disc 111 is connected to the inner disc 113 by means of a disc-connecting portion 115. FIG. 2A illustrates only the outer disc 111, whereas FIG. 2B illustrates only the outer disc 111 and the inner disc 113.

The outer disc 111 comprises an outer surface 117 that is configured so as to lie against a refrigerating compartment wall 107 (not illustrated in FIGS. 2A, 2B). The inner disc 113 comprises an inner surface 119.

Elevations 121 are arranged on the outer surface 117 of the outer disc 111 and on the inner surface 119 of the inner disc 113, wherein the elevations 121 comprise a rounded surface and in particular are configured as semi-spheres. The contact area of the damping disc 109 against the refrigerating compartment wall 107 is minimized by virtue of the elevations 121, whereby a particularly effective separation between the refrigerating compartment wall 107 and the damping disc 109 with regard to the transmission of vibrations is ensured.

In order to ensure an effective connection between the damping disc 109 and the refrigerating compartment wall 107, the damping disc 109 comprises a central through-going hole 123 that passes through the damping disc 109 and is arranged in a disc middle point 135 of the damping disc 109. An attachment dome (not illustrated in the FIGS. 2A, 2B) of the refrigerating compartment wall 107 may be guided through the central through-going hole 123 of the damping disc 109 in order to attach the damping disc 109 effectively to the refrigerating compartment wall 107.

Additional elevations 127 are arranged on an inner edge 125 of the central through-going hole 123, said additional elevations being configured so as to separate the fan and the attachment dome with regard to the transmission of vibrations. In this case, the additional elevations 127 are configured in particular as webs that extend at the inner edge 125 from the outer surface 117 to the inner surface 119 of the damping disc 109. The additional elevations 127, in particular webs, reduce the contact area between the damping disc 109 and the attachment dome on the refrigerating compartment wall 107, whereby it is possible to ensure a particularly effective separation with regard to the transmission of vibrations.

Moreover, the damping disc 109 comprises a multiplicity of through-going holes 131 that extend in a circumferential direction 129 of the damping disc 109, said through-going holes 131 being configured in particular as elongated holes. In this case, a middle axis 133 of the damping disc 109 extends in an orthogonal manner to a disc middle point 135 of the damping disc 109. The through-going holes 131 that extend in the circumferential direction 129 are arranged at least in sections in the circumferential direction 129 circumferentially around the middle axis. In this case, a first radial spacing 137 between the through-going holes 131 and the disc middle point 135 is less that a second radial spacing 139 between the elevations 121 and the disc middle point 135.

In the embodiment illustrated in FIG. 2, the through-going holes 131 form an inner circle of elongated holes, wherein the individual through-going holes 131 respectively are separated from one another by means of a web 141. The through-going holes 131 that extend along the circumferential direction 129 circumferentially around the middle axis 133 absorb a torque that occurs during the start-up of a fan motor or in the case of a speed change of the fan wheel of a fan of the refrigeration appliance 100. In this case, the inner circle of elongated holes that is formed by means of the through-going holes 131 may deform along the circumferential direction 129 in a specific frame irrespective of the outer contour of the damping disc 109 and as a consequence absorb the torque. After the torque has been absorbed, the through-going holes 131 may deform back into their original shape along the circumferential direction 129, whereby the torsional movements of the damping disc 109 may be absorbed in a particularly effective manner.

Consequently, the damping disc 109 ensures a particularly effective separation with regard to the transmission of vibrations since it is possible by means of the damping disc 109 both to absorb vibrations between the fan and the refrigerating compartment wall 107 and also to effectively damp or compensate torque that occurs, in particular torsional movement.

FIG. 3 illustrates a schematic representation in a side view of a damping disc 109 that may be attached to a fan of a refrigeration appliance 100. The damping disc 109 illustrated in FIG. 3 corresponds to the damping disc 109 illustrated in FIG. 2A and FIG. 2B. The damping disc 109 has an outer disc 111 with an outer surface 117 and an inner disc 113 with an inner surface 119. The outer disc 111 is connected to the inner disc 113 by means of a disc-connecting portion 115. A multiplicity of elevations 121 is arranged respectively on the outer surface 117 and on the inner surface 119, said elevations ensuring an effective separation between the fan and the refrigerating compartment wall 107 with regard to the transmission of vibrations.

A central through-going hole 123 and through-going holes 131 that extend in the circumferential direction 129 of the damping disc 109 are not illustrated in the view selected in FIG. 3. The disc-connecting portion 115 comprises a first diameter 143 that is less than a second diameter 145 of the outer disc 111 and less than a third diameter 147 of the inner disc 113. In this case, the second diameter 145 and the third diameter 147 are in particular equal in size.

FIG. 4 illustrates a schematic representation of a fan 149 that is attached to a refrigerating compartment wall 107 of the refrigeration appliance 100. The fan 149 is attached to a refrigerating compartment wall 107 of the refrigeration appliance 100. The fan 149 is configured so as to convey air via an air duct (not illustrated in FIG. 4) of the refrigeration appliance 100 to a refrigerating compartment 103.

The fan 149 comprises a fan unit 151 having a fan motor (not illustrated in FIG. 4) and having a fan wheel for conveying cool air out of the air duct into the refrigerating compartment 103. The fan unit 151 is connected to a fan holding device 153 of the fan 149 by means of a releasable connection, in particular a bayonet connection, wherein the fan holding device 153 is configured so as to attach the fan 149 to the refrigerating compartment wall 107. In this case, the fan 149 is arranged in particular in a wall recess 155 on a rear face of the refrigerating compartment wall 107 of the refrigeration appliance 100 and said fan is connected by means of an electrical cable 157 to an electrical current supply of the refrigeration appliance 100.

The fan holding device 153 comprises holding arms 159, in particular three holding arms 159, which are configured so as to attach the fan 149 to the refrigerating compartment wall 107. In this case, attachment domes 161, in particular three attachment domes 161, are arranged on the refrigerating compartment wall 107, wherein the attachment domes 161 respectively are guided through a connecting opening (not illustrated in FIG. 4) of a connecting portion 163 of the respective holding arm 159.

In order to prevent an effective separation between the fan 149 and the refrigerating compartment 107 with regard to the transmission of vibrations, a damping disc 109 is arranged respectively on the respective connecting portion 163 of the respective holding arm 159, wherein with respect to the design of the damping disc 109 reference is made to the embodiments described in accordance with FIGS. 2A, 2B and 3. In this case, the respective damping disc 109 is arranged in particular between the respective attachment dome 161 and the respective connecting portion 163 in order to ensure a particularly effective separation between the fan 149 and the refrigeration compartment wall 107 with regard to the transmission of vibrations.

FIG. 5 illustrates a sectional view of a connection between a fan 149 and a refrigerating compartment wall 107 of the refrigeration appliance 100.

The refrigeration appliance 100 comprises a fan 149 having a fan unit 151 for conveying cool air from the air duct into the refrigerating compartment 103 of the refrigeration appliance 100. The fan unit 151 of the fan 149 is connected to a fan holding device 153 of the fan 149, wherein the fan holding device 153 comprises a multiplicity of holding arms 159, in particular three holding arms 159, in order to connect the fan 149 to a refrigerating compartment wall 107 of the refrigeration appliance 100. One of the holding arms 159 having a connecting portion 163 is represented in the sectional view illustrated in FIG. 5, wherein the connecting portion 163 is connected to an attachment dome 161 of the refrigeration compartment wall 107. In this case, a damping disc 109 is arranged between the connecting portion 163 of the holding arm 159 and the attachment dome 161 of the refrigerating compartment wall 107 in order to separate the fan 149 and the refrigerating compartment 107 with regard to the transmission of vibrations.

The damping disc 109 comprises an outer disc 111 and an inner disc 113, which are connected by means of a disc-connecting portion 115. Elevations 121 (not illustrated in FIG. 5) are arranged on an outer surface 117 of the outer disc 111 and on an inner surface 119 of the inner disc 113. The elevations 121 reduce the contact area between the outer disc 111 and the refrigerating compartment wall 107.

The first diameter 143 of the disc-connecting portion 115 is less than the second diameter 145 of the outer disc 111 and the first diameter 143 is less than the third diameter 147 of the inner disc 113 with the result that a circumferential recess 165 is formed in the damping disc 109 between the outer disc 111 and the inner disc 113. The connecting portion 163 of the holding arm 159 of the fan 149 engages in the circumferential recess 165, wherein the connecting portion 163 engages over the disc-connecting portion 115 of the damping disc 109 at least in sections in order to connect the damping disc 109 to the holding arm 159 in particular in a positive locking and/or non-positive locking manner.

The damping disc 109 has a central through-going hole 123, through which the attachment dome 161 is guided in order to position the damping disc 109 against the attachment dome 161. In this case, the attachment dome 161 lies against the inner wall 125 of the central through-going hole 123. The attachment dome 161 comprises in this case an attachment protrusion 167 that lies against the inner surface 119 of the inner disc 113 in order to fix the damping disc 109 between the connecting portion 163 and the attachment dome 161, in particular in a positive locking and/or non-positive locking manner.

The damping disc 109 moreover has a multiplicity of through-going holes 131 that extend in the circumferential direction 129 of the damping disc 109 and are arranged at least in sections in a circumferential manner around a middle axis 133 of the damping disc 109, wherein the through-going holes 131 respectively are separated from one another by means of a web 141. The through-going holes 131 render possible an effective compensation of a torque that is generated by the fan 149.

Consequently, the damping disc 109 is advantageously configured so as to separate the fan 149 and the refrigerating compartment wall 107 with regard to the transmission of vibrations in order not to transmit different frequencies, which are generated by means of the fan motor of the fan 149 at different rotational speeds, directly to the refrigerating compartment wall 107 and consequently not to transmit said frequencies directly to adjoining components of the refrigeration appliance 100. Consequently, the degree of freedom when designing other attachment parts is increased since in this case it is no longer top priority to take into consideration a particularly high vibration resistance. In addition, by means of specifically selecting the material of the damping disc 109, in particular the Shore hardness or rather the increase or decrease in length of the dimensions of the through-going holes 131 or rather a change in the geometrical shape of the elevations 121, or rather of the additional elevations, it is possible to advantageously adapt the degree of damping for other radial fans 149.

All the features that are explained and illustrated in connection with individual embodiments of the invention may be provided in different combination in the subject matter in accordance with the invention in order at the same time to realize their advantageous effects.

The scope of protection of the present invention is provided by means of the claims and is not limited by means of the features explained in the description or illustrated in the figures.

### LIST OF REFERENCE NUMERALS

100 Refrigeration appliance
101 Refrigeration appliance door
103 Refrigerating compartment
105 Housing outer wall
107 Refrigerating compartment wall
109 Damping disc
111 Outer disc
113 Inner disc
115 Disc-connecting portion
117 Outer surface
119 Inner surface
121 Elevations
123 Central through-going hole
125 Inner edge of the central through-going hole
127 Additional elevations
129 Circumferential direction
131 Through-going holes
133 Middle axis of the damping disc
135 Disc middle point of the damping disc
137 First radial spacing
139 Second radial spacing
141 Web between the through-going holes
143 First diameter of the disc-connecting portion
145 Second diameter of the outer disc
147 Third diameter of the inner disc
149 Fan
151 Fan unit
153 Fan holding device
155 Wall recess
157 Electrical cable
159 Holding arm
161 Attachment dome
163 Connecting portion
165 Circumferential recess
167 Attachment protrusion

1-15. (canceled)

16. A refrigeration appliance, comprising:
a refrigerating compartment wall defining a refrigerating compartment for receiving chilled goods;
an air duct;
a fan attached to said refrigerating compartment wall and configured to convey air via said air duct to said refrigerating compartment; and
a damping disc disposed on a side of said fan facing said refrigerating compartment wall, said damping disc having a plurality of elevations lying against said refrigerating compartment wall, said damping disc having a plurality of through-going holes formed therein and extending in a circumferential direction of said damping disc, said damping disc configured so as to damp vibrations that occur during an operation of said fan in order to separate said fan and said refrigerating compartment wall with regard to a transmission of the vibrations.

17. The refrigeration appliance according to claim 16, wherein said damping disc has an outer surface and an inner surface, wherein said elevations are disposed on said outer surface and/or on said inner surface and wherein said outer surface and/or said inner surface lie against said refrigerating compartment wall.

18. The refrigeration appliance according to claim 16, wherein said damping disc has an outer disc, a disc-connecting portion and an inner disc, wherein said outer disc is connected to said inner disc by means of said disc-connecting portion, wherein said disc-connecting portion has a first diameter, said outer disc has a second diameter and said inner disc has a third diameter, wherein said first diameter is less than said second diameter and wherein said first diameter is less than said third diameter.

19. The refrigeration appliance according to claim 16, wherein said elevations respectively have a rounded surface.

20. The refrigeration appliance according to claim 16, wherein said damping disc has a middle axis that extends from a disc middle point of said damping disc in an orthogonal manner to a disc side of said damping disc, wherein said through-going holes that extend in the circumferential direction of said damping disc are disposed at least in sections in a circumferential manner around the middle axis.

21. The refrigeration appliance according to claim 16, wherein said through-going holes that extend in the circumferential direction of said damping disc are configured as elongated holes.

22. The refrigeration appliance according to claim 16,
wherein said damping disc has a central through-going hole formed therein that is disposed in a disc middle of said damping disc;
further comprising an attachment dome disposed on said refrigerating compartment wall; and
wherein said central through-going hole is configured so as to receive said attachment dome in order to attach said damping disc to said refrigerating compartment wall.

23. The refrigeration appliance according to claim 22, wherein said attachment dome has an attachment protrusion, wherein the attachment protrusion is configured so as to attach said damping disc between said fan and said refrigerating compartment wall, in a forming locking manner and/or in a force locking manner.

24. The refrigeration appliance according to claim 22, wherein:
said central through-going hole is defined by means of an inner edge of said damping disc;
a plurality of additional elevations is formed on said inner edge, wherein said additional elevations are configured so as to separate said fan and said refrigerating compartment wall with regard to the transmission of the vibrations, and wherein said additional elevations are configured as webs that extend on said inner edge from an outer surface to an inner surface of said damping disc.

25. The refrigeration appliance according to claim 16, wherein said damping disc is formed from an elastically deformable material.

26. The refrigeration appliance according to claim 16,
further comprising an attachment dome disposed on said refrigerating compartment wall;
wherein said fan has at least one connecting portion, said connecting portion has a connecting opening formed therein and into said connecting opening it is possible to insert said attachment dome in order to connect said fan to said refrigerating compartment wall; and
wherein said damping disc is disposed between said connecting portion and said refrigerating compartment wall in order to separate said fan and said refrigerating compartment wall with regard to the transmission of the vibrations.

27. The refrigeration appliance according to claim 16, wherein said fan has a fan unit that is configured so as to convey the air to said refrigerating compartment, and that said fan has a fan holding device that is configured so as to fix said fan to said refrigerating compartment wall.

28. The refrigeration appliance according to claim 27, wherein said fan has a releasable connection, said fan unit is connected to said fan holding device by means of said releasable connection.

29. The refrigeration appliance according to claim 27, wherein said fan holding device has at least one holding arm, said holding arm respectively has a connecting portion that is connected to said refrigerating compartment wall.

30. The refrigeration appliance according to claim 29, wherein said damping disc has a circumferential recess formed therein, wherein said connecting portion is configured so as to engage into said circumferential recess in order to connect said damping disc to said connecting portion, and wherein said damping disc is connected to said connecting portion.

31. The refrigeration appliance according to claim 16, wherein said elevations are configured as semi-spheres.

32. The refrigeration appliance according to claim 16, wherein said damping disc is formed from silicone.

33. The refrigeration appliance according to claim 27, wherein said releasable connection is a bayonet connection.

34. The refrigeration appliance according to claim 30, wherein said damping disc is connected to said connecting portion by a form-locking connection and/or a force locking connection.
